(19) United States
(12) Patent Application Publication
(10) Pub. No.: US 2025/0076965 A1
(43) Pub. Date: Mar. 6, 2025

(54) METHOD FOR PROVIDING VIRTUAL REALITY SPACE SERVICE HAVING PHYSICAL RANGE DEFINED BY BLUETOOTH BEACON, AND SYSTEM THEREFOR

(71) Applicant: HWACOM CO., LTD., Seoul (KR)

(72) Inventors: Seok Ki KIM, Seoul (KR); Jung In CHOI, Anyang-si (KR); Jae Kyu LEE, Seoul (KR); Keol HEO, Seoul (KR); Hyun Seo LIM, Seoul (KR)

(21) Appl. No.: 18/716,046

(22) PCT Filed: May 19, 2022
(86) PCT No.: PCT/KR2022/007172

§ 371 Date: Nov. 25, 2024

(30) Foreign Application Priority Data
Dec. 3, 2021 (KR) 10-2021-0171481

(51) Int. Cl. G06F 3/01; G06Q 20/36; G06Q 50/00; G06T 13/40; H04B 17/318; H04W 4/80

(52) U.S. Cl. CPC G06F 3/011; G06Q 20/36; G06Q 50/01; G06T 13/40; H04B 17/318; H04W 4/80

(57) ABSTRACT

The present disclosure relates to a method and system therefor for providing a community service, such as a messenger, an SNS, and a metaverse in a virtual reality space where a physical range is defined by a Bluetooth beacon and, specifically, to the method and system for providing the service to allow a user terminal having received this, based on a range which this packet may reach, to use the community service through a wide area network within a variable yet clearly bounded physical space (Higgsverse), allowing the beacon to broadcast an arbitrary packet by utilizing a Bluetooth network. This makes it possible to physically interact with actual objects that exist within a space in which one currently exists.

### FIELD OF THE INVENTION

The present disclosure relates to a method for providing a virtual reality space service and a system therefor, and more specifically to the method and system for providing the virtual reality space service corresponding to this offline community in a space that a physical range is defined by a Bluetooth beacon when an arbitrary offline community exists.

### DESCRIPTION OF THE RELATED ART

As a network has developed, online community services, having utilized this network, such as a messenger, a SNS, and a metaverse service, etc. have also developed greatly. In this of 41 the network has also made a process, a development contribution. Furthermore, an improvement of terminals used by users have also made a significant contribution. The development of the network and the terminals, in this way, has contributed to a creation of various types of the online community services. Meanwhile, despite a steady development of the online community services as above, the online community services have encountered limitations due to a fact that an origin of service is still purely online. Additionally, since there have been restrictions on exchanging information with each other through online and a procedure that a certain level of security is necessarily corrected must be carried out (e.g., a procedure to share information that each other may be identified, such as IDs between members, phone numbers, etc.) in order to interact with each other, there have been problems and inconveniences in that there have still been major barriers to interacting with an unspecified number of diverse people.

In particular, consumers are still finding their own advantages and enjoyments even in offline activities. Since there have also been clearly unique characteristics of offline services not to be felt in online services, a form of service to achieve a mutual harmony between offline and online has been required.

The present disclosure relates to a new form of service to put together offline and online. It is intended to solve technical problems discussed above, as well as to provide additional technical elements that may not be easily invented by those skilled in the present art.

### SUMMARY

It is one of objects of the present disclosure to provide a method and a system therefor for providing virtual reality space services corresponding to the spaces to users visiting these spaces, when offline-based spaces, such as cafes and restaurants, exist.

In particular, various aspects of the present disclosure are directed to limiting a range of accessible users', by allowing a user, who visits offline spaces, to receive a packet which is broadcast from a Bluetooth beacon and allowing only a user having received the packet to use the virtual reality space services.

Additionally, various aspects of the present disclosure are directed to enabling a user to have new experiences, by allowing various user actions, which may be performed in an internal space of the offline space, to be performed in a virtual reality space.

Additionally, various aspects of the present disclosure are directed to enabling a user and an operator to have new experiences in terms of digital twins by digitizing objects that exist offline in the virtual reality space and allowing the objects to be added. In other words, this refers to a new service ecosystem that a virtual reality space is created in a new universe, namely, ‘Higgsverse’ (Higgs is a physical phenomenon in which software has mass and becomes hardware in the beginning) for coexisting in a specific physical space where one exists. This Higgsverse requires an implementation of technical elements that a physical space, which the Bluetooth beacon may reach, is clearly defined as a boundary.

Meanwhile, technical challenges of the present disclosure are not limited to what was mentioned above, and other technical challenges not mentioned may be clearly understood by those skilled in the art from descriptions below.

In order to solve the above problems, a method for providing a virtual reality space service by a service server, the method, comprising: providing at least one of a messenger service, a social network service, or a metaverse service among a plurality of user terminals that exist in a range within which a Bluetooth signal transmitted from a specific beacon may be reached, wherein a reachable range of the Bluetooth signal transmitted from the specific beacon is defined based on a signal strength.

Meanwhile, according to an embodiment of the present disclosure, the method, further comprising: receiving a community entry request-the community entry request includes a community identifier received through a local area network from a beacon by the user terminal-from a user terminal; and allowing a community access of the user terminal, wherein the beacon is installed in an offline space and broadcasts a packet containing a community identifier corresponding to the offline space, wherein the community is set in a virtual reality space realized in 3D corresponding to the offline space.

Also, the method, further comprising: creating a community corresponding to the offline space, before the receiving of the community entry request from the user terminal, wherein the community is created by utilizing a plurality of templates or authored contents provided by the service server.

Also, the method, further comprising: displaying a virtual character corresponding to a user of the user terminal on the community, after the allowing of the community access of the user terminal.

Also, the method, further comprising: implementing an appearance or movement of the virtual character within the community according to a user manipulation input from the user terminal, after the displaying of the virtual character on the community.

Also, at this time, the user manipulation input is for moving a virtual character within the community, for starting a conversation with another virtual character within the community, for starting an interaction with an item existing within the community, or for purchasing an exclusive item to a virtual character.

Also, the user manipulation input, further including: registering an item corresponding to the product for a product purchased by the user in an arbitrary offline space, wherein the implementing of an appearance or movement of the virtual character is the applying and displaying the registered item on the virtual character.

Also, the method, further comprising: issuing a usable digital currency within the community, wherein a purchase within the community is made using the digital currency.

### DESCRIPTION OF DRAWINGS

FIG. 1 is a diagram for conceptually explaining a virtual reality space service according to the present disclosure.

FIG. 2 shows a configuration of a system for providing the virtual reality space service according to the present disclosure.

FIG. 3 shows an exemplary embodiment of a method for providing the virtual reality space service according to the present disclosure.

FIGS. 4 and 5 illustrate an exemplary embodiment of an application screen running on a user terminal.

FIG. 6 shows an exemplary embodiment of a virtual reality space displayed through an application.

FIG. 7 is a diagram for explaining a plurality of objects added to a virtual character.

FIG. 8 illustrates a Higgsverse space in an easy-to-understand way

### DETAILED DESCRIPTION

Details, with regard to an object and a technical configuration of the present disclosure and operational effect thereof, will be more clearly understood by the following detailed description based on the drawings attached to a specification of the present disclosure. Exemplary embodiments according to the present disclosure will be described in detail with reference to the accompanying drawings.

Embodiments disclosed in this specification should not be construed or utilized as limiting a scope of the present disclosure. It is natural to those skilled in the art that descriptions, including exemplary embodiments, of this specification should have various applications. Accordingly, arbitrary embodiments described in the detailed descriptions of the present description is illustrative to better explain the present description, and is not intended to limit a scope of the present description to the exemplary embodiments.

Functional blocks shown in the drawings and described below are only embodiments of possible implementations. Other functional blocks may be used within a range without departing from a spirit and scope of the detailed description in other implementations. Additionally, although one or more functional blocks of the present disclosure is represented as individual blocks, one or more of the functional blocks of the present disclosure may be a combination of various hardware and software components which perform the same function.

In addition, since an expression that certain components are included is an expression of “open”, the expression simply refers to a presence of the corresponding components, and should not be understood as excluding additional components.

Furthermore, when a certain component is said to be “connected” or “coupled” to another component, it may be directly connected or coupled to other thereof, however it should be understood that other components may exist in between.

Hereinafter, each exemplary embodiment of the present disclosure will be looked at with reference to the drawings below.

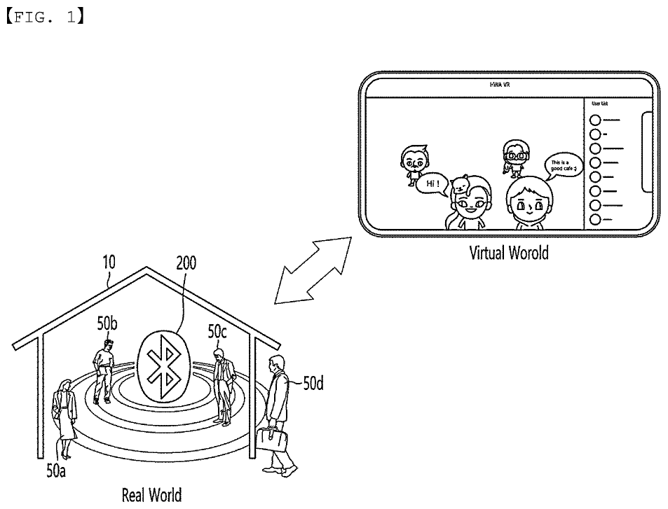

First, FIG. 1 is a diagram for easily understanding a beacon-based virtual reality space service according to the present disclosure, and is a rough representation of services which are provided, in case that a plurality of users visits an arbitrary offline space, namely, a cafe.

Referring to FIG. 1, a picture of an actual offline space is shown on the left, and a picture of a virtual reality space is shown on the right. A plurality of users (50a to 50d) is those that have already entered or are about to enter the cafe in order to use an offline space (10) called the café. User terminals carried by these users may display the virtual reality space on the right side of the drawing on each of their own user terminals via a specific packet from a beacon (200) installed in the offline space (10). For example, the user (50a) may open a door to the offline space (10) and simultaneously receive a push message from an application installed on his or her smartphone (the user terminal). By clicking on this push message, a user terminal of his or hers may allow a chat room or the virtual reality space corresponding to the offline space (10) to be displayed on the smartphone. At this time, a push message may be generated based on a packet which has been broadcast from the beacon (200), and within the packet, a community identifier to identify the chat room or the virtual reality space corresponding to the offline space (10) may be included. For reference, the virtual reality space mentioned in the present disclosure may be named a so-called Blue Space.

Meanwhile, the virtual reality space is built on a service server (100) by an operator (or a manager) of the offline space (10), which virtual reality space may be a personalized virtual reality 3D space created to suit the operator's intention. The virtual reality space may be produced and generated by an application module operated by a 3D engine of the service server (100), and, on the operator's terminal (e.g. desktop PC), an interface environment to create the virtual reality space may be provided, which interface environment may be provided with an interface which allows for freely disposing several three-dimensional spaces, various props to be disposed in these three-dimensional spaces, various contents, etc. to be played in space. In addition, if the operator uploads a photo taken of the offline space (10) to the interface, a service that a three-dimensional space corresponding to this is created and provided may be implemented.

In addition, when referring to a picture on the right side of FIG. 1, it may be confirmed that a total of four virtual characters exist in the virtual reality space, which virtual characters correspond to users who received beacon packets from the actual offline space (10). The virtual characters within the virtual reality space may be capable of conversing with other virtual characters, ordering drinks, or engaging in other consumption behaviors or other actions, some of which behaviors or actions may lead to results displayed in the offline space (10). For example, when a virtual character orders a drink in the virtual reality space, there may be user experiences, such as an actual order being made, an actual drink being provided, etc. in the actual offline space (10).

As mentioned above, with reference to FIG. 1, a beacon-based virtual reality space service has been looked at according to the present disclosure.

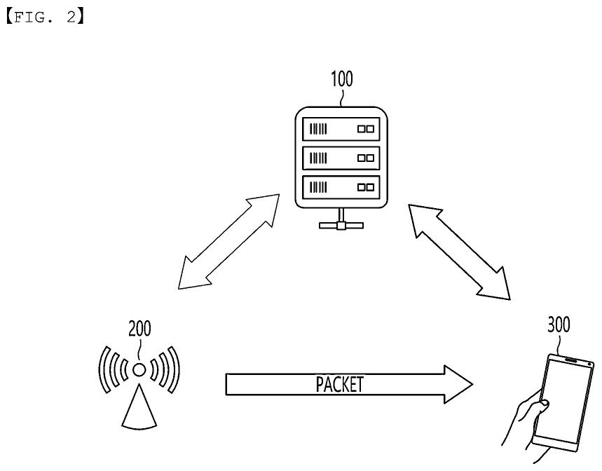

FIG. 2 shows hardware configurations required to provide a virtual reality space service above. Referring to the drawing, it may be seen that a service is possible by the service server (100), the beacon (200), and the user terminal (300) which are exchanging data with each other through a network.

First, the service server (100) is a configuration that provides a program, namely, a set of commands, for actually implementing a service according to the present disclosure and, furthermore, corresponds to a configuration that processes or stores various data received from a plurality of user terminals and various data received from operator terminals in some cases. A form of the service server (100) may be at least one server computer managed by a specific operator, or may be a kind of cloud servers provided by another company, namely, a cloud server which an operator may use when registering as a member. When the service server (100) is implemented as a server computer, the service server (100) may include a central processing unit and memory. The central processing unit may also be called a controller, a microcontroller, a microprocessor, a microcomputer, etc. Additionally, the central processing unit may be implemented by a hardware, a firmware, a software, or a combination thereof. When implemented using the hardware, the central processing unit may be composed of an ASIC (application specific integrated circuit) or a DSP (digital signal processor), a DSPD (digital signal processing device), a PLD (programmable logic device), a FPGA (field programmable gate array), etc., and when implemented using the firmware or software, the firmware or software may be composed of a module, a procedure, or a function, etc. that performs the above functions or operations. Additionally, the memory may be implemented as an ROM (Read Only Memory), an RAM (Random Access Memory), an EPROM (Erasable Programmable Read Only Memory), an EEPROM (Electrically Erasable Programmable Read-Only Memory), a flash memory, an SRAM (Static RAM, an HDD (Hard Disk Drive), an SSD (Solid State Drive), etc.

The beacon (200) refers to a short-range wireless communication device based on a Bluetooth protocol, and may include any device capable of periodically transmitting a signal to a surrounding area, namely, a packet, in order to transmit an arbitrary information. The beacon (200) mentioned in the present detailed description may be installed in an arbitrary offline space (10), and, preferably, may be installed in a virtual sphere whose radius is a distance, which is equal to a Bluetooth communication range of the beacon (200), so that a packet broadcasting through a Bluetooth communication may reach at least user terminals which are entering the offline space (10) by using an entrance of the offline space (10) as an origin. Since the beacon (200) is not necessarily installed only inside the offline space (10) but may also be installed outside the offline space (10), packets, which are broadcast to users standing within a predetermined radius around the offline space (10), may also be delivered. In this way, the packets which are broadcast may include information for marketing, and, in some cases, may be utilized for purposes, such as encouraging a membership registration in order to receive the virtual reality space service, providing a promotional information, or encouraging access to application download for using links services, etc.

Next, the user terminal (300) refers to a device that a user owns or carries, and such a user terminal may include a portable terminal, such as a smartphone, a PDA, a tablet PC, etc. It is presupposed that all of these user terminals (300) should be equipped with the central processing unit (CPU) and memory. For reference, in the present detailed description, the description will be made, assuming that the user terminal (300) is a smartphone or tablet PC in order to help understand of the present disclosure. In this case, the user terminal (300) may include a display and a touch-sensitive surface, and, furthermore, may further be connected to one or more other physical user input means, such as a physical keyboard, a mouse, and/or a joystick. Additionally, the user terminal (300) may further include a means for detecting and recording sound or voice. Meanwhile, various applications running on the user terminal (300) may optionally use at least one common means for a physical user input, such as a touch-sensitive surface. One or more functions of a touch-sensitive surface as well as a corresponding information displayed on a terminal may optionally be adjusted or changed application to next and/or within an individual application. In this method, a common physical architecture of device (such as a touch-sensitive surface) may support optionally various applications by utilizing a user interface that is intuitive and clear to a user.

Referring again to FIG. 2, it is shown that the service server (100) transmits and receives data with the user terminal (300) through a mutual network, and the beacon (200) broadcasts packets toward the user terminal (300). As it will be explained later, in a virtual reality space service according to the present disclosure, after the user terminal (300) receives a packet which is broadcast by the beacon (200), the service server (100) (via a wide area network) is connected with the user terminal (300) by referring to a community identifier included in this packet. Black arrows in FIG. 2 indicate a mutual data transmission and reception flow through a network. Meanwhile, a gray arrow is displayed between the service server (100) and the beacon (200), which means that the beacon (200) may operate independently regardless of the service server (100), or indicates that it is possible to change settings by connecting the beacon (200) with the service server (100) on the network. In an embodiment, the beacon (200) itself is an independent device and may broadcast a packet as it was set up at the time of production and delivery. For example, after a cafe operator, like this, purchases the beacons (200) according to a predetermined service operator by installing it within a café, the cafe operator may broadcast a determined packet to an unspecified number of user terminals (300), create an account corresponding to the beacon (200) through the service server (100) and then operate the virtual reality space service. In another embodiment, after purchasing an arbitrary beacon device and then installing it in the cafe, the cafe operator may connect a network communication with the beacon device, through which, may set the beacon (200) as he or she wants. In this process, after connecting with the service server (100), the cafe operator may set an overall virtual reality service environment by inputting information about the beacon (200) or sharing values determined for the beacon (200) with the service server (100).

As mentioned above, with reference to FIG. 2, an overall system configuration has been looked at for implementing beacon-based virtual reality space service.

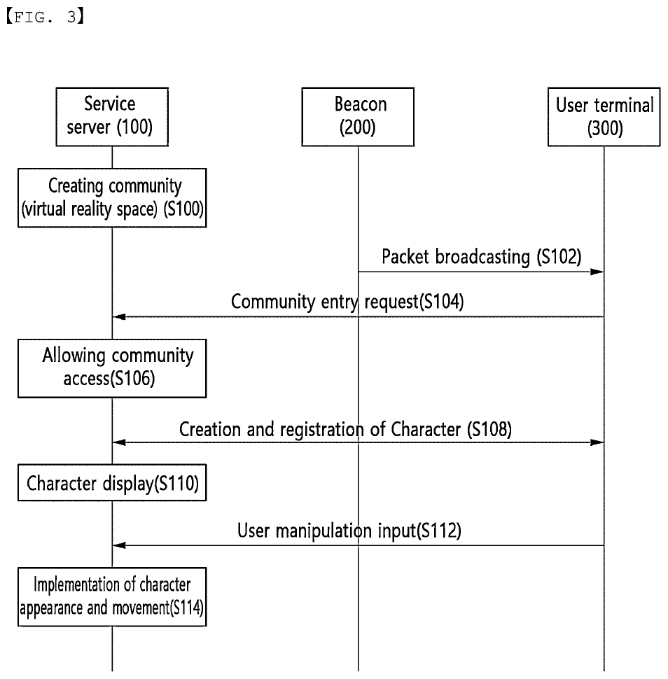

FIG. 3 briefly shows a process that the virtual reality space service according to the present disclosure is provided in regular sequence.

Referring to FIG. 3, a method for providing the virtual reality space service may begin from a step that a community is first created (S100). The community mentioned here refers to a space for an information communication exchange connected through a network provided by the service server (100), a type of which community may include a chat room or a three-dimensional virtual reality space. The community provided by the service server (100) may have been created and customized by an operator who operates the offline space (10). In particular, when the community is defined as the three-dimensional virtual reality space, the service server (100) allows an operator to directly create his or her own three-dimensional virtual reality space by providing the operator with an interface for creating and customizing the community. For example, after an operator who owns a cafe creates his or her own account on the service server (100) and registers as a member, she or he may create a three-dimensional virtual reality space similar to her or his own offline cafe by utilizing an interface provided by the service server (100), namely, an interface including various tools to directly decorate the three-dimensional virtual reality space. Meanwhile, in this process, an operator may upload photos of a space of the café, which he or she operates, to the service server (100). The service server (100) may customize a three-dimensional space based on the uploaded photos, which may be provide to the operator by the service server. In this method, the operator may own the three-dimensional virtual reality space matching her or his offline space. Meanwhile, the operator may also create her or his own virtual reality space, namely, a community, by purchasing a virtual reality space which is put up for sale by others. The community or virtual reality space according to the present disclosure may be bought and sold like an asset from the operator's point of view. Each community or virtual reality space may be defined as a value by taking into account the number of registered users, the average number of visitors who enter through a packet which is broadcast by a Bluetooth beacon, a cost spent on decorating the virtual reality space, or a period of time that the virtual reality space has been created and maintained, etc. In some cases, instead of creating a new community or virtual reality space, an arbitrary operator may create his or her own virtual reality space by purchasing a new community or virtual reality space which has already reached a certain level and which the number of users and visitors has passed a certain level of. Such a virtual reality space brokerage service may be provided by the service server (100), or may be provided by a separate server independent of the service server (100).

On a presupposition that a three-dimensional virtual reality space is created as a community in the step (S100), the beacon (200) installed in the offline space (10) may broadcast a packet toward an arbitrary user terminal (300) (S102). At this time, the user terminal, which exists in a vicinity of the offline space (10), may be within a Bluetooth network range of the beacon (200) and, more preferably, be a terminal of a user's who visited the offline space (10). The packet which is broadcast by the beacon (200) may basically include an identifier for identifying the community or virtual reality space created in the step (S100). The identifier included in the packet may include a letter, a number, a combination of the letter and number, etc. which the user terminal (300) may refer to, when accessing the community or virtual reality space, and such an identifier may exist in a form of a connection links and URL. Meanwhile, the packet may include not only a community identifier but also a service identifier (UUID) in order to identify this service.

The user terminal (300), which has received a packet in the step (S102), may transmit a community entry request to the service server (100) by referring to information contained in the packet (S104). The service server (100) may allow access to the user terminal (300) in response to the community entry request (S106). In one embodiment, if the user terminal (300) receives a packet, an application installed on the user terminal (300) by the received packet may display a message, which the community or virtual reality space service may be used with, on a display. A user may attempt to connect the community or virtual reality space by clicking a confirmation button included in this message. Alternatively, when the application installed on the user terminal (300) is executed, a community list to be connected is displayed, which, thereby, encourages the user to enter. What is worth noting, even if the user terminal (300) receives the packet from the beacon (200) through the Bluetooth network, is that the community entry request to the service server (100) may be made through a wide area network rather than a local area network. For example, the user terminal (300) may request a connection to a community, namely, a virtual reality space built on the service server (100) through a wide area network, such as an LTE communication network or a 5G communication network, etc. Meanwhile, there may remain a log record on the user terminal (300) or service server (100) in a community or a virtual reality space that a connection request has been made once, which log record may continue to exist unless deleted at a user's discretion.

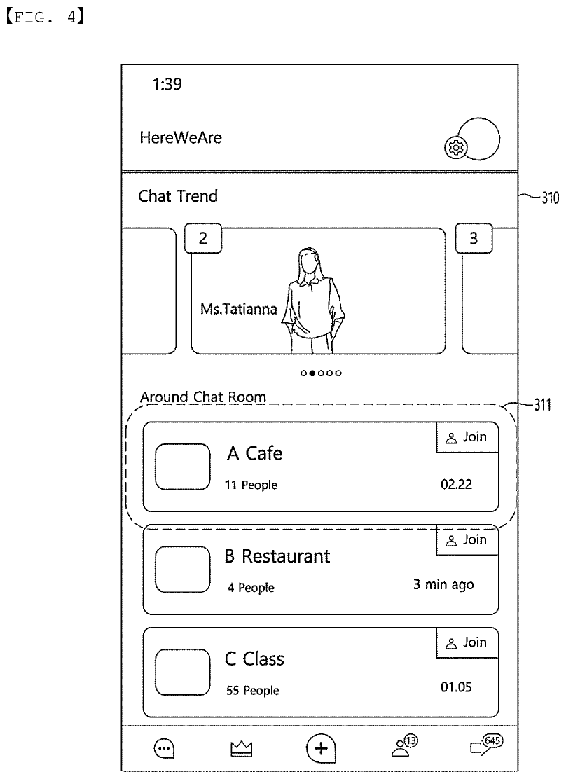

For reference, FIG. 4 shows an application screen running on the user terminal (300) of a user's having entered an offline space called an arbitrary café of “A Cafe”. When referring to this, among lists on an application screen (310), the user may see that a chat room or virtual reality space for entering the “A Cafe” is displayed, based on a packet received from the beacon (200).

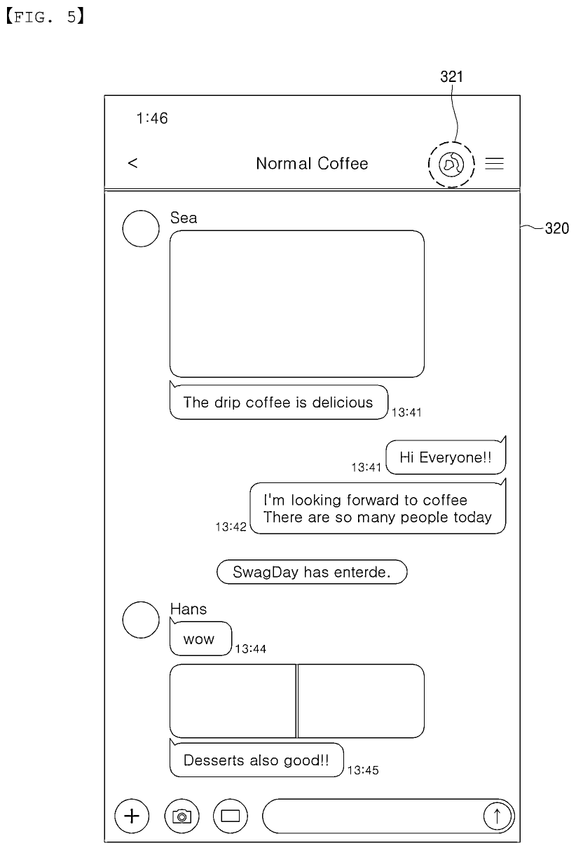

FIG. 5 illustrates an application screen (320) that a user has entered a community according to an access permission of the service server (100). In FIG. 5, when a chat room is defined as a community corresponding to the “A Cafe”, there is shown an appearance that a plurality of users has conversations within this chat room. At this time, whoever has received a packet from the beacon (200) may be all of the users in the chat room. In other words, it is possible that only users who actually exist in an offline space called the “A Cafe” participate in the chat room. Therefore, a beacon-based community may enable the function to be performed. Meanwhile, within the community, it is possible to be implemented so that users who do not currently exist in the “A Café” may also participate in chat. For example, it was mentioned that there may remain log records, where a user visited this cafe in the past, in the user terminal (300) or service server (100) and it is possible, by referring to this log record, that the user having visited in the past may participates in the community at any time. However, such users, by marking them separately within the community, may be differentiated from users existing in the offline space. On the other hand, a setting of a range for users to participate in the community may be changed by an operator operating the offline space. For example, it is possible that a setting is changed so that only users within a range to receive a packet from the beacon (200) may participate, so that people who have even once participated in this community may participate at any time, or so that anyone may participate. However, even in this case, an entry into the virtual reality space which will be described later allows a locality to be maintained by allowing only a user within a Bluetooth network range, namely, a user who is actually visiting the offline space, or a user who is very close to the offline space.

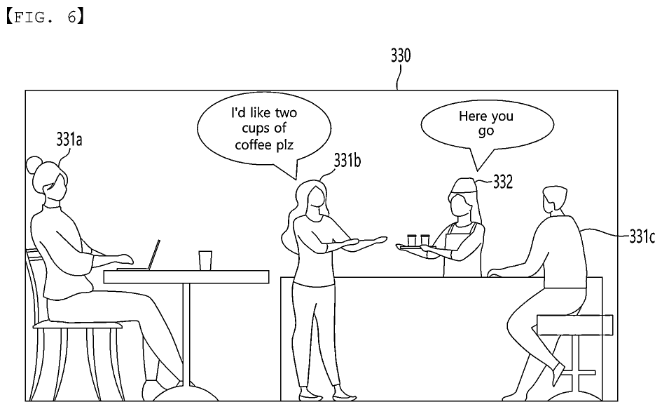

It may be confirmed that a separate icon (321) to enter the virtual reality space is further displayed at the top right of an application screen (320) in FIG. 5. When this icon (321) is clicked, an entry into the virtual reality space (330) proceeds as shown in FIG. 6 or on the right side of FIG. 1. As mentioned earlier, the virtual reality space (330) may be produced or purchased directly by an operator, and a customizing service may be provided on the service server side (100) in order to enable a production similar to an indoor space of the “A Café”.

After the step (S106), the service server (100), according to a request from a user, may support a creation and registration of a virtual character to replace a user within the virtual reality space (330) (S108). The virtual character is a character, such as 331a to 331c shown in FIG. 6, and it is possible to customize and register these characters by allowing each user to directly select items, such as gender, hairstyle, clothes, and shoes. The virtual characters (331) created in the step (S106) may be displayed (S110) within the virtual reality space (330). Meanwhile, in the virtual reality space, in addition to virtual characters corresponding to users, a virtual character (332) corresponding to an operator may also be displayed, and an interaction, such as a conversation and a transaction, etc. may occur among these virtual characters.

For reference, in FIG. 3, the user terminal (300) makes the community entry request (S104) to the service server (100), and after receiving the access permission about this (S106), it was shown that the virtual character is created and registered (S108). However, it should be understood that a process of creating and registering a virtual character is not limited to this. In other words, a user may create and register a virtual character at arbitrary time, and when visiting an offline space and entering a virtual reality space later, the user may use a virtual character that has been created and registered in advance. On the other hand, if a user does not want to expose an existence of a virtual character in a virtual reality space, the virtual character may be made even invisible to another virtual character depending on the user's setting. Alternatively, by providing a transparent item which a user may use after purchasing, it is possible for the user to use it after purchasing as needed.

After entering the virtual reality space and displaying even a virtual character, a user manipulation input may be transmitted to the service server (100) through the user terminal (300) (S112), and in response to this user manipulation input, the service server (100) implements an appearance or movement of the virtual character (S114), which is allowed to be displayed on the user terminal (300).

There may be many different types of the user manipulation input, which will be briefly looked at below.

In types of the user manipulation input, a manipulation input for moving a virtual character within the virtual reality space may be included. The virtual reality space may be formed as a three-dimensional space and furthermore may be implemented at the same scale or ratio as the actual offline space, and a user may transmit the manipulation input to the service server (100) for moving his or her virtual character to a desired location within this three-dimensional virtual reality space. The manipulation input for moving the virtual character like this may include an input for clicking on a desired destination point, an input for dragging in a desired direction, an input for pressing an arrow provided on the interface, etc.

In types of the user manipulation input, a manipulation input that a virtual character is allowed to obtain information may be further included. A plurality of other virtual characters and a plurality of objects may exist in the virtual reality space, and the manipulation input for obtaining the information may include clicking on the other virtual characters or an arbitrary object. For example, if another virtual character is clicked, the virtual reality space may be implemented so that some pieces of information (time of community-entering, time spent in community, name, gender, age, or contact information, etc.) about the corresponding virtual character are displayed through a display of the user terminal (300). In addition, when an arbitrary object, for example, a table placed in the virtual reality space, is clicked, the virtual reality space may be implemented so that some pieces of information about the corresponding table (specification, price, material, or place of purchase, etc.) are displayed.

Next, in types of the user manipulation input, a manipulation input that a virtual character is allowed to have a conversation with another virtual character may be further included. In the virtual reality space, other users' virtual characters are also active individually. Even if a conversation will not occur in the actual offline space, the conversation may occur in the virtual reality space, which function may be said to be more necessary for users, especially at a time of transition to a non-face-to-face society. For a conversation with another virtual character, a user may try to have the conversation with the corresponding virtual character by making manipulation inputs, such as clicking on another virtual character displayed on his or her user terminal (300), clicking on one of the current participating lists displayed on the user terminal (300), etc.

Next, in types of the user manipulation input, a manipulation input that a virtual character is allowed to make a predetermined movement shown or to exercise may be further included. The virtual reality space is not necessarily limited to a cafe and a restaurant, and may also be a space for showing a movement, such as a gymnasium, an indoor competition hall, etc., in which virtual reality space, a user may allow a virtual character to be visible to others or to participate in contests by having the virtual character perform a determined movement or exercise. For example, in case that a dance competition hall is implemented as a virtual reality space, a user may participate in the dance competition by imitating a choreography having directly been created offline, just as it is, onto the virtual character.

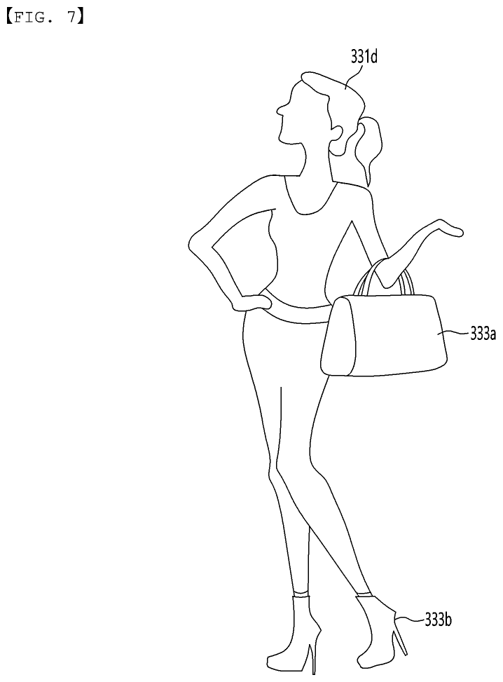

Meanwhile, in types of the user manipulation input, a manipulation input that a virtual character is allowed to purchase an arbitrary object existing in a virtual reality space may also be included. The virtual reality space may be a place that arbitrary products are sold, at which time, a user may purchase a desired product by making a series of inputs through the user terminal (300). For example, within a cafe, a user may make a series of inputs that a virtual character is allowed to order a cup of coffee, and when there is an order like this, even if it is ordered in a virtual reality space, an actual ordered coffee may be served in an offline space. Meanwhile, in case that a virtual reality space is built in response to a store which is selling luxury bags, a user views a bag which she or he wants in a virtual reality space and then may purchase it. At this time, for the purchased bag, an item to be used in the virtual reality space and a bag to be used in an actual offline space may be provided to a user separately. Furthermore, a product warranty provided in the offline space may be equally given in the virtual reality space, and the user may visit various virtual reality spaces in the offline space while holding the item corresponding to the luxury bag and the product warranty. On the other hand, for example, a figure, shown in FIG. 7, that a virtual character (331d) holds a bag (333a) and wears shoes (333b), which items are held by the virtual character, may be an ape who allows other users to find information about the above items, and may be used as a means to show her or his own items to other users from a perspective of an actual user corresponding to the virtual character (331d).

For reference, in types of the user manipulation input for purchase, a manipulation input for selecting an object, a manipulation input for a payment, and a manipulation input for an authentication may be included.

On the other hand, in types of the user manipulation input, A series of manipulation inputs for exchanging an object may also be included. Within the virtual reality space, a user may also exchange items, and, in a process of a mutual exchange with an opponent virtual character, a manipulation input may also be made for a transaction activity to exchange the items with each other. At this time, an exchange of the items does not necessarily have to be that of an item for an item, and may also be that of an item for cash. For example, in case that an arbitrary user purchases a used watch at a cafe, the user may purchase the used watch through an interaction with another virtual character with whom information has been shared in advance, and, at this time, an input for obtaining the information about a used watch product, an input for a payment (bank transfer), an input for authentication, etc. may be included.

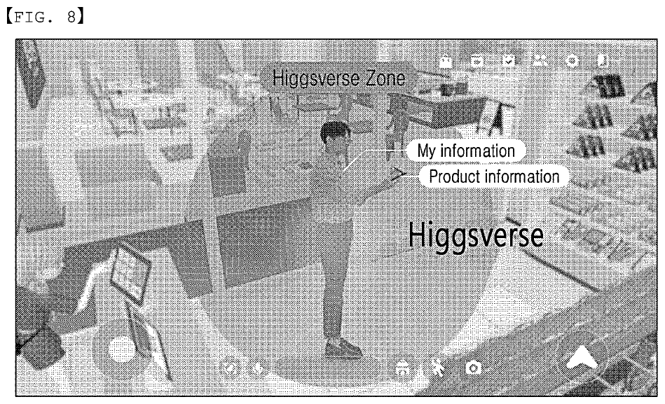

For reference, FIG. 8 is a diagram for helping understand the Higgsverse mentioned at the beginning of this detailed description. The Higgsverse may refer to a physical space whose boundary is defined as a range that a Bluetooth signal transmitted by an arbitrary beacon (a beacon that is fixedly installed in a specific location, or a beacon in a form of a portable terminal, such as a smartphone) is able to reach. In addition, a service according to the present disclosure relates to providing a messenger service, an SNS service, and/or a metaverse service among users who actually exist within the above the Higgsverse, and also to enabling an actual interaction with real things (people or objects) that exist in this

Higgsverse space.

A service based on the Higgsverse may have the following characteristics. First, in the present service, when defining a physical boundary of a Bluetooth space, it is possible to distinguish an opaque wall or a ceiling, etc. by setting a signal strength of the communication as a standard. In contrast, a transparent glass wall may be included within a Higgsverse space because signals may easily pass through the transparent glass. Such a Higgsverse space may be clearly defined as a space that an actual physical interaction (a distance that is able to be seen or touched) is possible, which space, therefore, may be fundamentally differentiated from a GPS-based LBS technology.

Next, in case of the messenger or the SNS service provided by the present service, the Higgsverse space may be defined as a space that an actual eye contact or a meeting is possible.

Additionally, in case of the metaverse service provided by the present service, a direct interaction with people or objects is possible, so it is possible to transact in cash or in kind.

As mentioned above, A method for providing the virtual reality space service that a physical range is defined by a Bluetooth beacon and a system therefor have been looked at. Meanwhile, the present disclosure is not limited to the specific embodiments and application examples described above, and in claims, it is natural that various modifications should be made by those with ordinary knowledge in the technical field to which the disclosure pertains, without departing from a gist of the claimed disclosure, which modifications should not be understood separately from a technical idea or outlook of the present disclosure.

### EXPLANATION OF SYMBOLS

10 Offline Space
100 Service Server
200 Beacon
300 User Terminal

What is claimed is:

1. A method for providing a virtual reality space service by a service server, the method, comprising:
providing at least one of a messenger service, a social network service, or a metaverse service among a plurality of user terminals that exist in a range within which a Bluetooth signal transmitted from a specific beacon may be reached,
wherein a reachable of range the Bluetooth signal transmitted from the specific beacon is defined based on a signal strength.

2. The method, further comprising:
receiving a community entry request-the community entry request includes a community identifier received through a local area network from a beacon by the user terminal-from a user terminal; and
allowing a community access of the user terminal,
wherein the beacon is installed in an offline space and broadcasts a packet containing a community identifier corresponding to the offline space,
wherein the community is set in a virtual reality space realized in 3D corresponding to the offline space.

3. The method according to claim 2, further comprising:
creating a community corresponding to the offline space, before the receiving of the community entry request from the user terminal,
wherein the community is created by utilizing a plurality of templates or authored contents provided by the service server.

4. The method according to claim 2, further comprising:
displaying a virtual character corresponding to a user of the user terminal on the community, after the allowing of the community access of the user terminal.

5. The method according to claim 4, further comprising:
implementing an appearance or movement of the virtual character within the community according to a user manipulation input: the user terminal, after the displaying of the virtual character on the community.

6. The method according to claim 5, wherein the user manipulation input is for moving a virtual character within the community, for starting a conversation with another virtual character within the community, for starting an interaction with an item existing within the community, or for purchasing an exclusive item to a virtual character.

7. The method according to claim 6, wherein the user manipulation input, further including:
registering an item corresponding to the product for a product purchased by the user in an arbitrary offline space,
wherein the implementing of an appearance or movement of the virtual character is the applying and displaying the registered item on the virtual character.

8. The method according to claim 2, further comprising:
issuing a usable digital currency within the community,
wherein a purchase within the community is made using the digital currency.
